(19) United States
(12) Patent Application Publication
(10) Pub. No.: US 2012/0137587 A1
(43) Pub. Date: Jun. 7, 2012

(54) SASH WINDOW HORN ARRANGEMENT

(75) Inventor: Harold Keith Braid, Bourne (GB)

(73) Assignee: CLEARVIEW INDUSTRIES LIMITED, Market Deeping (GB)

(21) Appl. No.: 13/306,664

(22) Filed: Nov. 29, 2011

(30) Foreign Application Priority Data
Nov. 30, 2010 (GB) 1020254.7
Nov. 9, 2011 (GB) 1119331.5

(51) Int. Cl. E06B 3/50; E06B 3/46

(52) U.S. Cl. 49/70

(57) ABSTRACT

A sash window system comprising a window frame including a side frame member, a window sash slidably mounted within the window frame, and a horn detachably connected to the sash. The horn further comprises at least one engagement feature which slidably engage the side frame member and slidably attach the horn to the window frame to retain horn to frame while allowing the horn to slide along the side frame member. The detachable connection arrangement preferably comprises a magnetic connection, comprising a magnet mounted on the horn which is attracted to the bottom of the sash and/or a metallic plate mounted therein.

The present invention relates to a sash window system and in particular to a sash window system with a decorative so-called horn feature on the sash. More particularly it relates to modern type sash window systems manufactured from modern materials such as aluminium, u-PVC, or other metallic material, with or without reinforcements, as opposed to traditional wood structures, and has particular application to a tiltable sash window system.

Sash window systems generally comprise a window frame in which a number, to usually two, moveable sashes are vertically slidably mounted to allow the window to be opened for ventilation.

The sashes can be fitted with small projections or decorative elements which are known as horns. The horns are usually situated on each side of the bottom of the top sash. These horns serve both functional and decorative purposes. The horns act as buffers or support members to limit the window frame movement. Particularly, they prevent the upper sash window frame from being lowered too far, i.e. to a level so low that the user would struggle gripping the window to raise it again. The horns prevent this from happening by engaging the window sill so that the upper sash can never be lowered to a level at or below that of the lower sash. Over the years the horns, which are usually of a distinctive curved shape, have also become a traditional decorative feature of sash windows.

Nowadays the traditional wooden sash window systems are increasingly being replaced by sash window systems manufactured from modern materials aluminium, u-PVC, or other metallic material, with or without reinforcements. UPVC windows have also become more popular for new buildings where a traditional sash window style is required.

In modern sash window systems the sashes are also configured so that they can be tilted out of the frame to allow access to the outside window surface to allow easy cleaning, by obviating the need to clean the windows from outside the building. When horn structures are provided at the lower edge of the sash at each side thereof this location produces geometric implications when the sash is tilted for cleaning purposes, due to the fact that the downwardly-projecting horn structure interferes with associated structures such as the sash window frame.

Accordingly various prior arrangements have been proposed to allow sashes with horn features to be tilted and prevent the horns restricting such tilting of the sashes. For example GB2311320 describes an arrangement in which a horn is slidably rather than fixedly mounted in association with the sash via a mounting plate attached to the sash. When the sash is tilted the horn is slid and pushed downwards away from the sash against a biasing spring along the mounting and is thus prevented from interfering with the tilting movement of the sash. A disadvantage of this construction is that the arrangement is relatively complex and expensive to manufacture.

GB2275956 describes an alternative arrangement in which the sashes are pivoted from the horns. This however requires that the entire sash is supported from the relatively weak horns projections rather than from the stronger and more rigid main sash structure.

In GB2261246 horns are hingedly connected to the sash window frame. Apart from a complicated construction, this arrangement has the further disadvantage that the hinge is visible from inside the window which is not appealing to the eye and does not look traditional.

GB2239283 discloses a sash window system with a frame structure and a sash window in which the horns are placed on the sashes such that the horns are positioned at a slight distance from the sash structure. In this way the horns do not interfere with the tilting of the window. These horns however do not have the visual appearance of traditional style horns because there is a gap between the horn and the frame structure.

GB2349667 describes an arrangement in which the horns are detachably connected to the bottom of the sash such that they can be removed to allow tilting, with there furthermore being a retention means, comprising a string, which connects the horn to the sash to prevent it from being completely removed from the sash and lost. While this provides a simple arrangement it requires a user to manually refit the horn to the bottom of the sash after tilting.

It is therefore desirable to provide an improved sash window system incorporating a horn feature on the sash which addresses the above described problems and/or which more generally offers improvements or an alternative to existing arrangements.

According to the present invention there is therefore provided a sash window system, and a horn for use in such a system, as described in the accompanying claims.

In an embodiment of the invention there is provided a sash window system comprising a window frame including a side frame member, a window sash slidably mounted within the window frame, and a horn detachably connected to the sash. The horn further comprises at least one engagement feature which slidably engages the side frame member and slidably attaches the horn to the window frame to retain horn to frame while allowing the horn to slide along the side frame member.

Advantageously the horn is retained on the window frame in a simple manner while it can be moved way from the sash to allow the sash to be titled.

The window side frame member typically comprises channel and the engagement feature engages the channel. Moreover the window side frame member may comprise at least one flange and the engagement feature engages the flange.

The engagement feature preferably comprises a projection from the horn which is engaged within the window side frame member.

Preferably the engagement feature is an integral part of the horn, for instance part of the same moulding.

Preferably the engagement feature projects from the horn into a channel provided by a side frame. Preferably the engagement feature includes one or more parts which extend behind one or more parts of the side frame and/or which extend away from the entrance to the channel, for instance away from a slot opening.

Moreover the engagement feature may comprise a hook or lip which engages a part of the window side frame member. Preferably the engagement feature comprises a pair of arms extending from the horn and which is engaged within the window side frame member. A distal end of engagement feature may be tapered to allow insertion into the window side frame member.

Alternatively the engagement feature may comprise a longitudinal slot within sides of the horn and wherein a portion of the window side frame member is engaged within the slot.

The engagement feature preferably comprises a pair of engagement features.

Preferably the engagement feature is snap fitted with the window side frame member. This allows the horn to be easily fitted.

In an alternative embodiment, the engagement feature may comprise a plate provided on the horn. The plate may be connected to the horn by an arm. One end of the arm may be connected to the plate. One end of the arm, preferably the other end, may be connected to the horn. The arm may be connected to the horn by the arm being received within a slot provided by the horn. The slot may be defined by one or more wall parts of the horn and/or one or more ribs provide within the horn. The arm may be connected to the horn by a part of the horn being received within the arm. The arm may be retained relative to the horn by adhesive.

The horn may have an engaged position, for instance in which it cannot be removed from and/or introduced to the window side frame. The horn may have a released position, for instance in which it can be removed from and/or introduced to the window side frame. The horn may be moved from the engaged position to the released position by rotation of the horn. The horn may be moved from the released position to the engaged position by rotation of the horn.

The horn may face or abut a surface of the side frame. The plate may be substantially parallel to the surface of the side frame, particularly in the engaged position. The plate may extend substantially perpendicularly to the arm. The arm may be substantially perpendicular to the surface of the side frame, particularly in the engaged position.

The entrance to the channel in the window side frame, for instance the slot opening, may have a minimum width, for instance considered perpendicular to the long axis of the channel provided therein and/or parallel to the surface of the side frame. The minimum width is preferably less than a width dimension for the plate. The width dimension of the plate may be considered perpendicular to the long axis of the channel provided therein and/or parallel to the surface of the side frame, particularly with the horn in the engaged position. The width dimension of the plate may prevent movement or inhibit movement of the horn perpendicular to the surface when in the engaged position. The minimum width is preferably greater than a height dimension for the plate. The height dimension of the plate may be considered parallel to the long axis of the channel provided therein and/or parallel to the surface of the side frame, particularly with the horn in the engaged position. The height dimension of the plate may allow movement or removal of the horn perpendicular to the surface when in the released position.

In an further alternative embodiment, the engagement feature may comprise one or more, preferably two, elements extending from the horn.

The element may be connected to the horn by an arm, for instance in the form of a neck portion. The neck may have a width which is between 10% and 65% of the width of the widest part of the element. The widest part of the element may be provided by the part distal from the horn.

The element may be T-shaped, for instance with the neck providing the stem of the T-shape. The element may engage two flanges provided by the window side frame, for instance to either side of a channel.

The element may be L-shaped, for instance with the neck providing the stem of the L-shape. The element may engage one flange provided by the window side frame, for instance to one side of a channel.

The element may have a depth which is less than 20% of the width of the neck portion, more preferably less than 15% of the width of the neck portion. The element may have a depth which is less than 10% of the width of the widest part of the element.

The widest part of the element may be less than 80% of the width of the widest part of the horn. The widest part of the element may be more than 50% of the width of the widest part of the horn.

A first element may be provided at one end of the horn, for instance the end proximal the window sash in use, and/or be provided with another element at another end of the horn, for instance the end distal the window sash in use.

One or both or all of the elements may be provided as an extension or continuation of a wall of the horn. One element may be provided by an extension or continuation of the top wall of the horn. One element may be provided by an extension or continuation of the bottom wall of the horn. One or both or all the elements may be planar. Where two or more elements are provided, two or more of those elements may be parallel to each other.

The horn may have an engaged position, for instance in which it cannot be removed from and/or introduced to the window side frame. The horn may have a released position, for instance in which it can be removed from and/or introduced to the window side frame. The horn may be moved from the released position to the engaged position by passing at least a part of an extension through a part of the channel provided with an increased width and/or by passing at least a part of the extension through a gap in a part of the window side frame. The gap may be a notch, for instance a notch removed from the window side frame and particularly from a flange bordering a channel in which the horn is slideably received. Two or more gaps, such as notches may be provided. At least one side of the window side frame is preferably provided with a gap, such as a notch, for each element on the corresponding side of the horn. Both sides of the window side frame may be provided with a gap, such as a notch, for each element on the corresponding side of the horn.

The horn may be moved from the released position to the engaged position by inserting the elements, preferably those on one side of the horn, into a channel in the window side frame, ideally without any part of the element(s) passing through a gap or gaps. The horn may then be rotated so as to bring the other side of the horn towards the window side frame. This may cause at least a part of the element(s) to pass through a gap or gaps in the window side frame.

The gap or gaps may be provided in the window side frame during its production and/or may be provided in the window side frame after production, including after installation of the sash window system.

The horn may be moved from the engaged position to the released position by passing at least a part of an extension through a part of the channel provided with an increased width and/or by passing at least a part of the extension through a gap in a part of the window side frame. The gap may be a notch, for instance a notch removed from the window side frame and particularly from a flange bordering a channel in which the horn is slideably received. Two or more gaps, such as notches may be provided. At least one side of the window side frame is preferably provided with a gap, such as a notch, for each element on the corresponding side of the horn. Both sides of the window side frame may be provided with a gap, such as a notch, for each element on the corresponding side of the horn.

The horn may be moved from the engaged position to the released position by rotating the horn so as to move one side of the horn away from the window side frame. This may cause at least a part of the element(s) to pass through a gap or gaps in the window side frame. The elements on the other side of the horn may be removed from the channel in the window side frame, ideally without any part of the element(s) passing through a gap or gaps.

The entrance to the channel in the window side frame, for instance the slot opening, may have a minimum width, for instance considered perpendicular to the long axis of the channel provided therein and/or parallel to the surface of the side frame. The minimum width is preferably less than a width dimension for one or more or all of the elements. The width dimension of the element(s) may be considered perpendicular to the long axis of the channel provided therein and/or parallel to the surface of the side frame, particularly with the horn in the engaged position. The width dimension of the element(s) may prevent movement or inhibit movement of the horn perpendicular to the surface when in the engaged position.

The rear face of the horn and the widest part of the element may be provided with a separation, preferably considered perpendicular to the long axis of the channel, and/or parallel to plane of the element, which is equal to the thickness of the channel wall sandwiched between them plus a tolerance.

Preferably the sash window system further comprises a detachable connection arrangement detachably connecting the horn to the sash. The detachable connection arrangement preferably comprises a magnetic connection. In particular the sash window system preferably further comprises a magnet mounted on the horn. Alternatively other detachable connection arrangements may be used, fro example a Velcro attachments.

Such a detachable connection, in particular a magnetic connection allows the horn to be easily connected to the sash whilst also detached to allow tilting with minimal user interaction. In particular the magnetic connection will automatically connect the horn to the sash when placed near the horn.

The magnet may be fixed in position on the horn. The magnet may be provided in a magnet receiving recess in the horn. The magnet receiving recess may be defined by one or more wall parts of the horn and/or one or more ribs provide within the horn. The magnet may be held in the magnet receiving recess by a magnet cover. The magnet cover may be glued or otherwise attached to the horn. The magnet cover may by a U-shaped profile, particularly with the magnet accommodated between the arms of the U-shape. The arms of the magnet cover may be inserted into the magnet receiving slot.

The sash is preferably also pivotally mounted to the window frame such that the sash can be pivoted out of the plane of the window frame.

In an embodiment of another aspect of the invention there is provided a horn for use in a sash window system comprising at least one engagement feature for slidable engagement with a side frame member of a window frame of the sash window system and for slidably attaching the horn to the window side frame to retain horn to frame while allowing the horn to slide along the side frame member.

The present invention will now be described by way of example only with reference to the following figures in which:

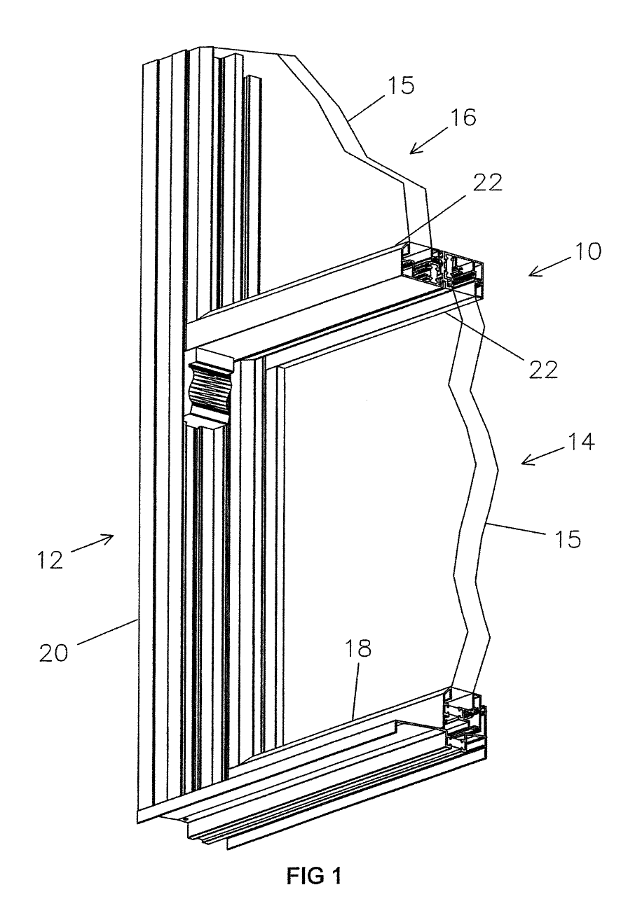

FIG. 1 is a diagrammatic perspective part view of a sash window system incorporating the present invention;

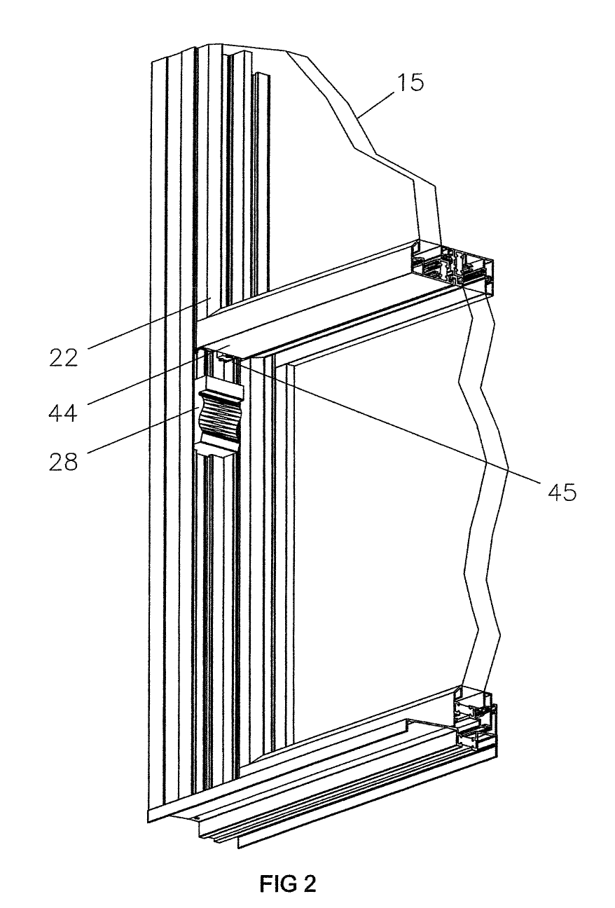

FIG. 2 is a diagrammatic perspective part view similar to FIG. 1 but showing the sash horn vertically detached from the window sash;

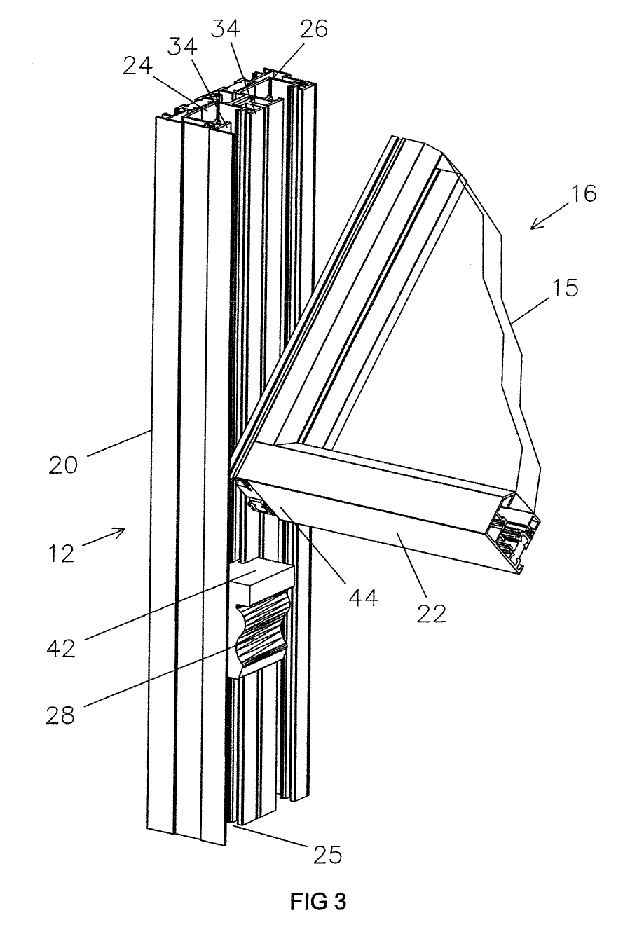

FIG. 3 is a diagrammatic perspective part view similar to FIGS. 1 and 2 but showing the window sash in a tilted position;

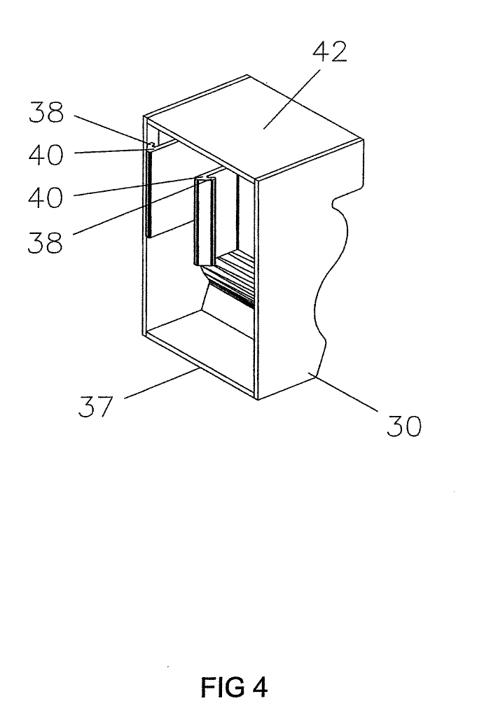

FIG. 4 is a diagrammatic rear perspective view of the horn of the sash window systems shown in FIGS. 1 to 3;

FIG. 5 is a diagrammatic exploded perspective view of the horn shown in FIG. 4;

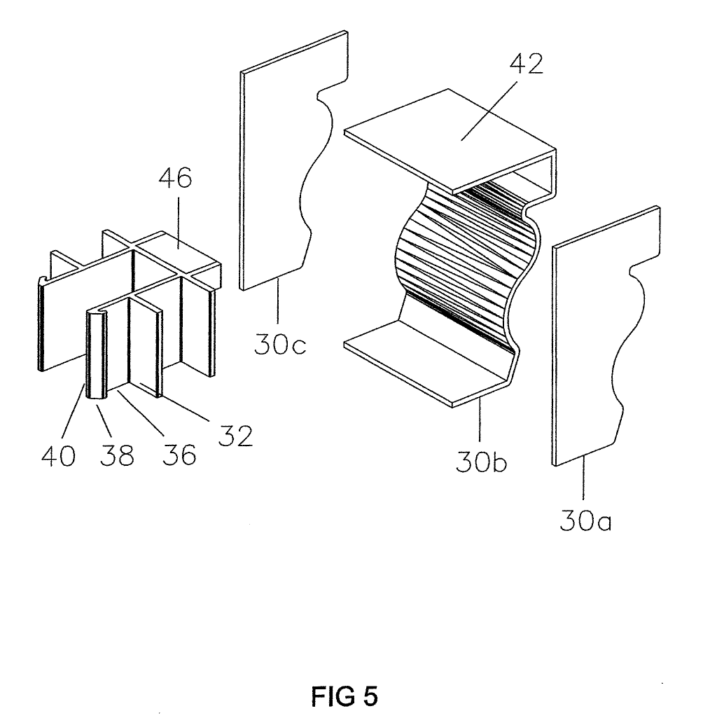

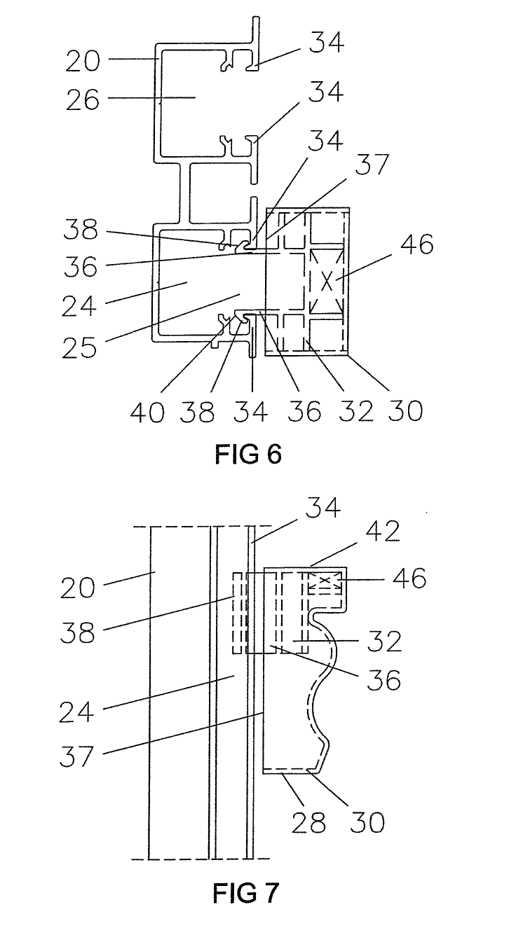

FIG. 6 is a diagrammatic cross sectional view through the side window frame and sash horn shown in FIG. 1;

FIG. 7 is a more detailed schematic front view showing the sash horn fitted into the sash window side frame;

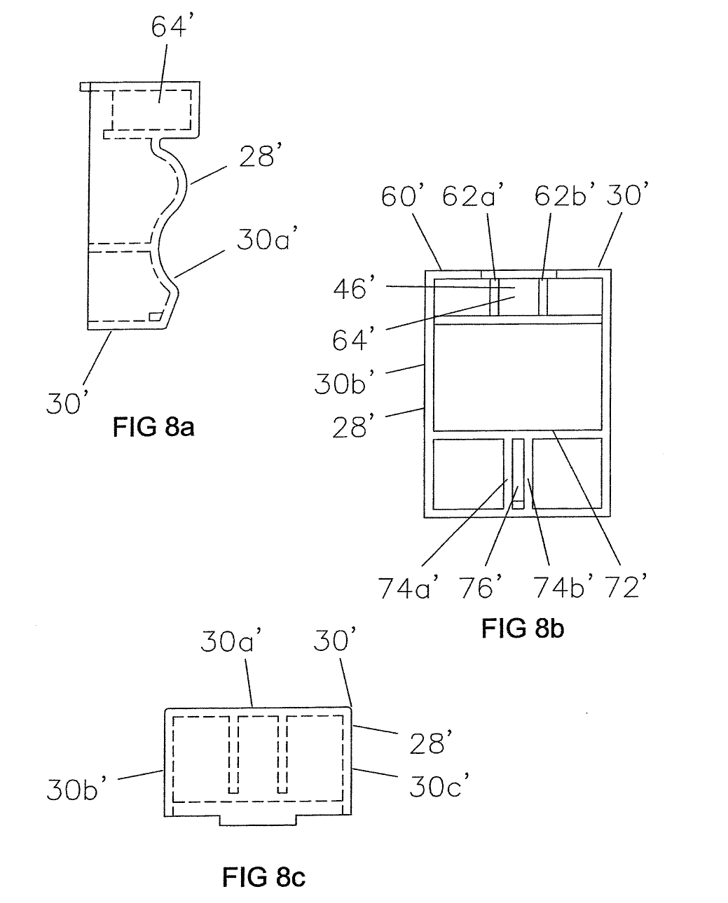

FIG. 8a is a side view of a second embodiment of a horn according to the present invention;

FIG. 8b is a rear view of the horn of FIG. 8a;

FIG. 8c is a top view of the horn of FIG. 8a showing just the magnet receiving recess;

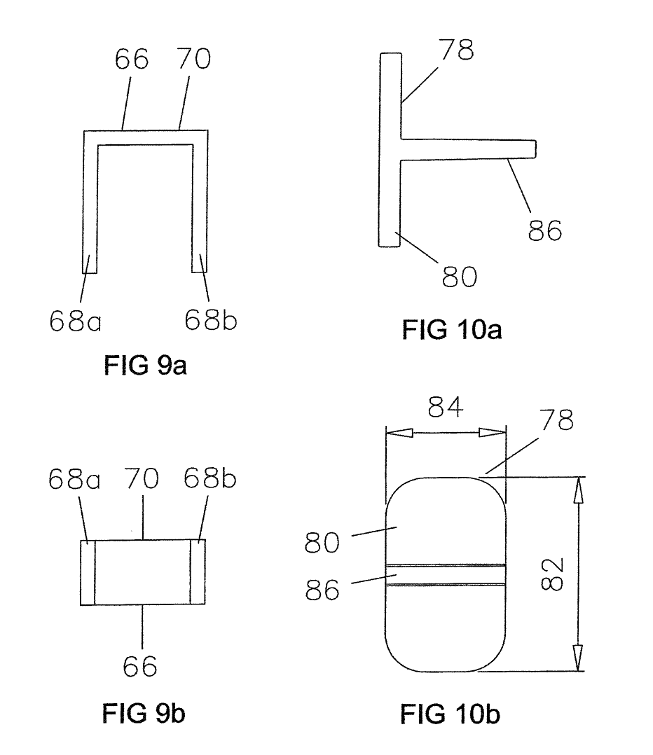

FIG. 9a is a plan view of a magnet cover;

FIG. 9b is a front view of the magnet cover of FIG. 9a;

FIG. 10a is a plan view of a horn retainer;

FIG. 10b is a front view of a horn retainer;

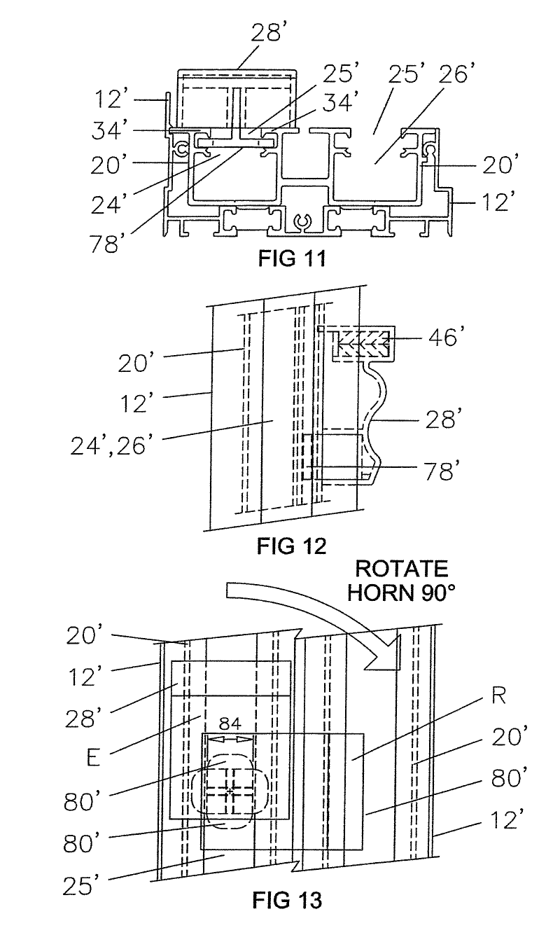

FIG. 11 is a diagrammatic cross sectional view, viewed from below, through the side window frame and through the sash horn of FIGS. 8a to 10;

FIG. 12 is a diagrammatic cross sectional view, viewed from the side, through the side window frame and through the sash horn of FIGS. 8a to 10;

FIG. 13 is a diagrammatic view of the side window frame and sash horn showing the engaged and released positions for the sash horn relative to the side window frame;

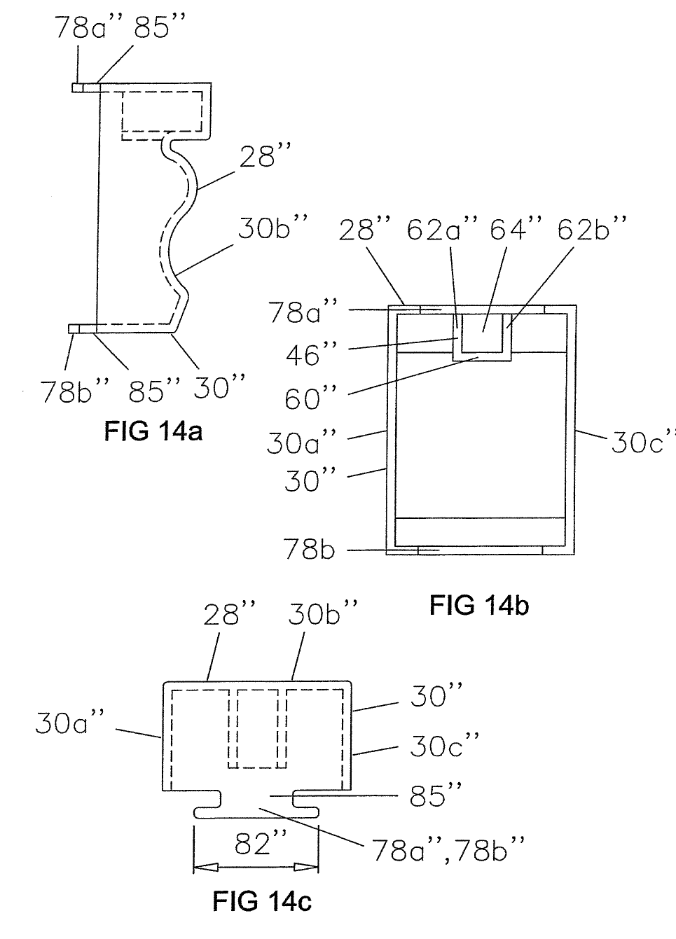

FIG. 14a is a side view of a third embodiment of a horn according to the present invention;

FIG. 14b is a rear view of the horn of FIG. 14a;

FIG. 14c is a top view of the horn of FIG. 14a showing just the magnet receiving recess;

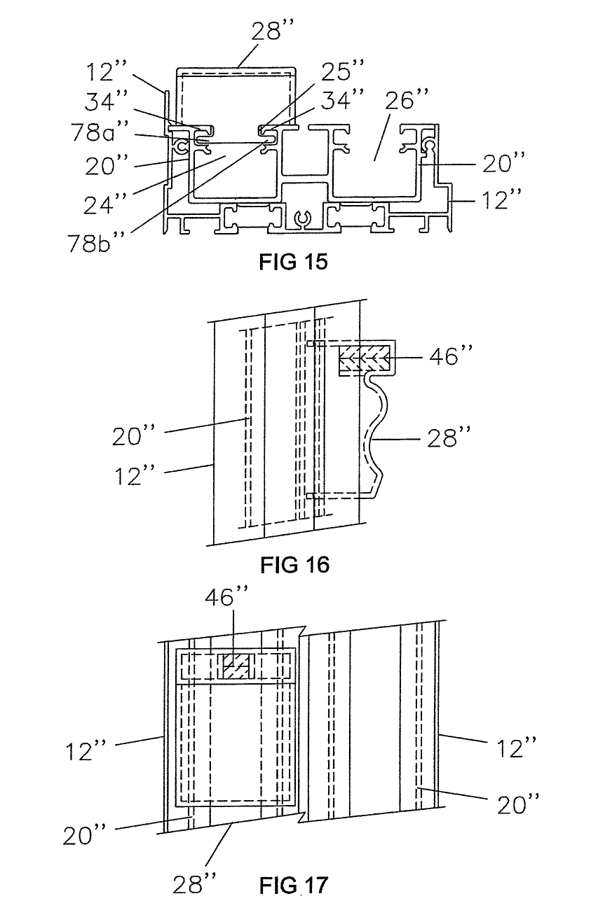

FIG. 15 is a diagrammatic cross sectional view, viewed from below, through the side window frame and through the sash horn of FIGS. 14a to 14c;

FIG. 16 is a diagrammatic cross sectional view, viewed from the side, through the side window frame and through the sash horn of FIGS. 14a to 14c;

FIG. 17 is a diagrammatic view of the side window frame and sash horn showing the engaged positions for the sash horn relative to the side window frame for the sash horn of FIGS. 14a to 14c; and

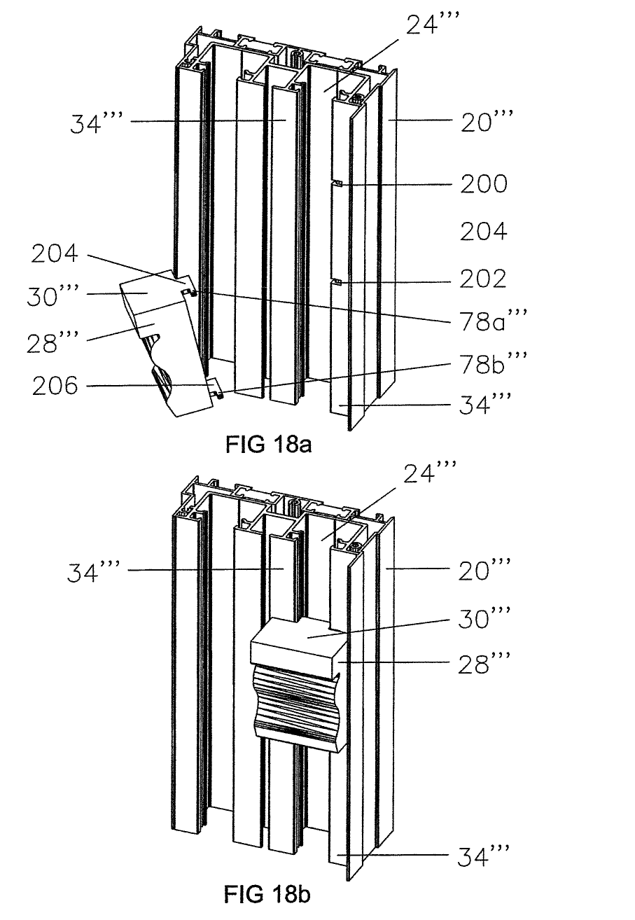

FIGS. 18a and 18b are perspective views showing the introduction (FIG. 18a) of a sash horn according to a further embodiment of the invention into engagement (FIG. 18b) with the side window frame.

Referring firstly to FIGS. 1 to 3, there is shown a corner part of a sash window system 10 comprising a window frame 12 with a head (not shown) within which are vertically slidably mounted a pair of window sashes 14, 16. The window frame 12 comprises a rectangular frame of two horizontal sill members 18 (only the lower sill is shown in FIG. 1), and a pair of window side frames 20 (only the one side is shown in FIG. 1). Each of the window sashes 14, 16 comprises an outer rectangular sash frame 22 holding a glass pane 15, typically a sealed double glazing unit. The window frame 12 and sash frames 22 typically comprise elongate extrusions of aluminium, or plastic material such as uPVC or glass reinforced plastic (GRP).

The window sashes 14, 16 are vertically slidably mounted within the window frame 12 by lower steel pivot pins (not shown) that project laterally from the lower end of the sides of the sash frame 22 and engage slidable sash shoes (not shown) slidably located within elongate recessed channels 24, 26 extending vertically within the window side frame 20 to locate and mount the lower end of the window sashes 14, 16. Upper latch pins (not shown) project laterally from the upper end of the sides of the sash frame 16 frame and are located within the window side frame channels to locate the upper part of the window sashes 14, 16. Separate parallel channels 24, 26 with openings 25 facing the sides of the sashes 14, 16 spaced side by side within each the window side frame 20 are provided for each respective window sash 14, 16. A cross sectional through the window side frame 20 more clearly showing the elongate channel sections 24, 26 is shown in FIG. 6 and it is these elongate channels 24, 26 that the sash shoe and pivot pins (not shown) are located within. A counterbalance mechanism is also located within the side window frame 20 and is connected to the sash shoe to counterbalance the weight of the window sashes 14, 16 allowing them to be more easily slid within the window frame 12.

The upper pivot latch pins are preferably retractable such that their distal ends can be withdrawn from the window side frame 20 to allow the upper part of the window sashes 14, 16 to be tilted out of the plane of the window frame 12 and pivot, as shown in FIG. 3, about the lower pivot pins (not shown). As such the sash window system 10 is typical of modern sash window systems. The window sashes 14, 16 may however be vertically slidable mounted within the window frame 12 in other ways.

In addition while typically two vertically slidable window sashes 14, 16 are provided with one sash 14, 16 sliding behind the other, in other arrangements there may be only one slidable sash 14, 16 sliding behind or in front of a fixed window panel and/or more than two slidable sashes 14, 16 may be provided.

The sash window system 10 also comprises a pair of horns 28 associated typically on each side of the bottom of and below the top sash 16. The horn 28 is shown in more detail in FIGS. 4 and 5. Each horn 28 is in this case a hollow structure comprising an outer moulded plastic shell 30 (which may be formed from a number of pieces 30a, 30b, 30c) which has an exterior shape that mimics the traditional shape of a horn on a traditional wooden sash window; although other shapes are possible. The outer shell 30 is supported on an inner support rib structure 32 integrally connected to the shell 30. The horn 28 and shell 30 and inner support structure 32, are preferably made from a plastic material similar to, and visually compatible with the sash frame 22 and/or window frame 12 material.

In other embodiments the horn 28 may however comprise a solid structure or have other more detailed configuration. For example the horn may comprise a single moulded (e.g. injection moulded) unitary plastic structure moulded from plastic (for example uPVC or GRP) or may be die cast aluminium rather than being assembled from separate parts as shown. Other configurations are also contemplated.

The horn 28 engages and is slidably mounted and located to the window side frame 20 such that when installed it is slidable fixed and attached to the window side frame 20 but can slide vertically along the length of the window side frame 20 as shown in FIG. 2. More specifically, and in this embodiment, the window side frames 20 include flanges or lips 34 adjacent to the window sashes 14, 16 and extending along the length of the window side frame 20 and which partially close off and define the window frame channel 24, 26, as is shown more clearly in FIG. 6. An opening 25 into the channels 24, 26, into which the pivot and latch pins project, is defined between the distal edges of the flanges 34. The flanges 34 define and provide a facing side edge surface of the window side frames 20. The horns 28, and in this case horn support structure 32, include engagement features which project from the rear 37 of the horns 28 and engage the window side frame 20, and in particular extend into and engage the window frame channel 24. The engagement features engage the flanges 34 to thereby retain and locate the horn 28 on the window side frame 20 with the rear 37 of the horn 28 abutting against the facing surface of the flanges 34 and window side frame 20 and being held in such an abutting position by the engagement features.

Preferably the engagement features, as shown, comprise a pair of arm ribs 36 which project from the rear 37 of the horn 28 and support rib structure 32. The arms 36 are laterally spaced apart similarly to the spacing of the opening slot 25 of window frame channel 24 to fit snugly within the opening 25 between the flanges 34. The arms 36 have a hooked distal end 38 extending laterally outwardly from the arms 36 and arranged to locate and engage behind the flanges 34 of the window side frame 20. Preferably the arms 36 have a degree of resilience and are flexible such that they can be deflected inwardly towards each other to allow the hooked ends 38 to be fitted passed and behind the flanges 34. To assist the distal end of the arms 36 have an angled and tapered profile 40 to urge the arms 36 inwards and into the opening when the horn 28 and arms 36 are pushed into the opening 25 between the flanges 34 allowing the horns 28 and arms 36 to be snap fitted into the slot opening 25 and window channel 24. Alternatively an enlarged channel access opening sized to receive the hooked ends 38 (and which may be provide for other reasons for example to install the sash shoe and/or counterbalance) may be provided part way along the window side frame 20 and into which the hook ends 38 can be inserted with the horn 28 then slid along the channel 24 with the hooked ends 38 behind the flanges 34. This provides a simple and convenient way of locating the horn 28 with the window 10 using the existing channel and frame structure.

It will however be appreciated that other engagement arrangements to slidably engage and locate the horn 28 to the window side frame 20 may be used. For example the horn may include elongate longitudinal slots vertically along the sides and towards the rear of the horn into which the window frame flanges 34 may extend and be located the slidably retain the horn.

The horn 28 also comprises a detachable connection arrangement for detachably connecting the horn 28 and top of the horn 42 to the bottom 44 of the window sash 16. When attached, as shown in FIG. 1, the horn 28 moves with the sash 16 as the sash 16 slides within the window frame 12 and appears as an integral part of the window sash 16 similarly to traditional horns. The horn 28 can however, by such a detachable connection, be detached from the bottom of the sash, while still being attached to the window side frame 20, as shown in FIGS. 2 and 3, to thereby allow the sash 16 to tilt unhindered as shown in FIG. 3.

Preferably the detachable connection arrangement comprises a magnetic connection arrangement magnetically connecting the horn 28 to the sash 16. In particular the horn 28 includes a magnet 46 mounted within the horn 28 and in this case horn support structure 32. The magnet may in other embodiments be fitted and located in or on the horn in other ways. For example a recess may be provided in the top of the horn within which the magnet can be located and secured either by an interference fit and/or adhesive. The magnet 46 is attracted to the steel pivot bar (not shown) located at the bottom of the window sash 16 with the magnetic force between the magnet 46 and steel pivot bar holding the horn 28 in place abutting against the bottom 44 of the window sash 16. Alternatively a specific steel or similar plate, or cooperating magnet may be fitted and incorporated into and within the bottom of sash frame 22 of the window sash 16 and to which the magnet 46 is attracted to thereby connect the horn 28. In yet other variants, a metallic plate may be located in on or within the horn 28 and a magnet placed in the bottom of sash frame 22. The magnet 46 and steel pivot bar can be brought into proximity with one another, so that the magnetic force holds the horn 28 in place abutting the bottom 44 of the window sash 16 by moving the horn 28 up towards the window sash 16, by moving the window sash 16 down towards the horn 28 or a combination of both movements.

The horn 28 may be simply detached from the sash 16 by either pulling the horn 28 away from the bottom of the sash 16 against the magnetic force, and/or when the sash 16 and bottom surface 44 is titled and pivoted away from the top 42 of the horn 28 this forcing the top 42 of the horn 28 away from the bottom surface 44 of the sash 16. To reattach the horn 28 it is simply slid upwards so that the top 42 of the horn 28 abuts the bottom surface 44 of the sash 16 where the magnet 46 then holds it in place. This magnetic attachment of the horn 28 provides a simple means for connecting the horn 28 the window sash 16 with minimal additional components, and whilst allowing the horn 28 to be easily detached to allow pivoting of the window sash 16, and for the horn 28 to then be simply reattached.

Other, non magnetic, detachable connection arrangement may be used in other embodiments, but are less preferred. For example Velcro or a simple mechanical press fit stud arrangement could be used similar to that described in GB 2349667.

While the invention is particularly directed to tiltable sashes, and has particular advantages when used on such windows, it can also be used on non-titling sash windows. In addition while the horns 28 are traditionally provided only on the bottom of top sashes 16, horns may also be provided on for example the top of a lower sash 14.

A further embodiment of the invention is illustrated with reference to FIGS. 8a to 13. In this case, each of the horns 28′ is a hollow structure comprising an outer moulded plastic shell 30′ formed as a unitary element to give a first side 30b′, front face 30a′ and second side 30c′ which has an exterior shape that mimics the traditional shape of a horn on a traditional wooden sash window.

Within the shell 30 are series of ribs are provided, again as a unitary element with the shell 30.

At the top of the hollow structure, a cross rib 60 is provided which spans from first side 30b′ to second side 30c′. Two vertical ribs 62a, 62b extend from the cross rib 60 to the top of the shell 30. The two vertical ribs 62a, 62b and part of the cross rib 60 and shell 30 between them define a magnet receiving recess 64 which is provided with a magnet 46′.

Whilst the magnet 46′ may be glued into the magnet receiving recess 64, it is preferred that it is held in place by a magnet cover 66, shown in FIGS. 9a and 9b. The magnet cover 66 is formed in a U-shape with a pair of arms 68a, 68b and a base 70 between them. The outside width of the magnet cover 66 is designed to be a snug fit within the magnet receiving recess 64. Adhesive may be used to assist the retention of the magnet cover 66 in the recess 64. The magnet 46′ in turn is a snug fit within the magnet cover 66. As a result, a reliable position for the magnet 46′ within the horn 28′ is provided at all times and movement of the magnet 46′ relative to the horn 28′ is resisted.

At the bottom of the hollow structure, a cross rib 72 is provided which spans from first side 30b′ to second side 30c′. Two vertical ribs 74a, 74b extend down from the cross rib 72 to the bottom of the shell 30. The two vertical ribs 74a, 74b and part of the cross rib 72 and shell 30 between them define a slot 76 with which a horn retainer 78 engages.

The horn retainer 78 is shown in FIGS. 10a and 10b. The horn retainer 78 is formed of a plate 80 which has a width 82 and a height 84. The width 82 is configured to be greater than the minimum width of the slot opening 25′ in the channel 24. The height 84 is configured to be less than the minimum width of the slot opening 25′ in the channel 24. Extending from the plate 80 is an arm 86. The external profile of the arm 86 is sized and shaped to be a snug fit in the slot 76 in the shell 30. Retention may be assisted by an adhesive in the slot 76 or other means. As a consequence, the horn 28 is firmly connected to the horn retainer 78.

The operation of the horn retainer 78 and other components is illustrated in FIGS. 11, 12 and 13. As shown from below in FIG. 11, again the window side frames 20′ include flanges or lips 34′ adjacent to the window sashes 14, 16 and extending along the length of the window side frames 20′ and which partially close off and define the window frame channel 24′, 26′. The slot opening 25′ into the channels 24′, 26′ is defined between the distal edges of the flanges 34′. The flanges 34′ define and provide a facing side edge surface of the window side frames 20′. The horns 28′ again include engagement features which project from the rear of the horns 28′ and engage the window side frames 20′, and in particular extend into and engage the window frame channel 24′. The engagement features again engage the flanges 34′ to thereby retain and locate the horn 28′ on the window side frame 20′ with the rear of the horn 28′ abutting against the facing surface of the flanges 34′. In this case, the engagement features are provided by extremities of the horn retainer 78.

The engagement features are provided by the horn retainer 78 because the width 82 of the plate 80 exceeds the width of the slot opening 25′. Hence the ends of the plate 80 abut the rear face of the flanges 34′.

In this way, once again, the horn 28′ engages and is slideably mounted and located to the window side frame 20′ such that when installed it is slideable fixed and attached to the window side frame 20′ but can slide vertically along the length of the window side frame 20′ as shown in FIG. 2 for the previous embodiment.

The magnet 46′ acts in the same manner as described in the first embodiment to hold the horn 28′ in position relative to the bottom of sash frame 22 of the window sash 16′.

With the long axis of the horn 28′ aligned with the axis of the channels 24′, 26′ in the window side frames 20′, as shown in FIGS. 11 and 12, the horn retainer 78 holds the horn in position on the window side frames 20′. This orientation is also shown in the engaged position E in FIG. 13.

If it is desired to remove the horn 28′ from the window side frame 20′, then the horn 28′ is rotated through 90° to the released position R in FIG. 13. In this orientation, the height 84 of the plate 80 is presented to the slot opening 25′. As the height 84 is configured to be less than the minimum width of the slot opening 25′ in the channel 24, then the horn 28′ and attached plate 80 can simply be pulled out and away from the window side frame 20′ to detach the horn 28′.

To attach a horn 28′ to the window side frame 20, the horn 28′ is positioned relative to the window side frame 20′ with the height 84 presented to the slot opening 25′ and the horn 28′ is pushed towards the window side frame 20′ such that the plate 80 enters the slot opening 25′ and goes into the channel 24. Rotation through 90° then presents the width 82 to the slot opening 25; and gives retention. The horn 28′ is also the in the desired orientation for use.

A further embodiment of the invention is illustrated with reference to FIGS. 14a to 17. In this case, each of the horns 28″ is a hollow structure comprising an outer moulded plastic shell 30″ formed as a unitary element to give a first side 30a″, front face 30b″ and second side 30c″ which has an exterior shape that mimics the traditional shape of a horn on a traditional wooden sash window.

Within the shell 30″ a series of ribs are provided, again as a unitary element with the shell 30″.

At the top of the hollow structure, two vertical ribs 62a″, 62b″ extend from down from the top of the shell 30″ to a cross rib 60″ which is provided between the two vertical ribs 62a″, 62b″. The two vertical ribs 62a″, 62b″ and part of the cross rib 60″ and shell 30″ between them define a magnet receiving recess 64″ which is provided with a magnet 46″.

Whilst the magnet 46″ may be glued into the magnet receiving recess 64″, it is preferred that it is held in place by a magnet cover, not shown but of the type shown in FIGS. 9a and 9b. As a result, a reliable position for the magnet 46″ within the horn 28″ is provided at all times and movement of the magnet 46″ relative to the horn 28″ is resisted.

Integrally provided with the horn 28″ are a top horn retainer 78a″ and a bottom horn retainer 78b″. The horn retainers 78a″, 78b″ are formed by a rearward extension of the top of the shell 30 and the bottom of the shell 30 respectively. The rearmost part of each has a width 82″, where the width 82″ is configured to be greater than the minimum width of the slot opening 25″ in the channel 24″.

The wider rearmost part is connected to the shell 30 by a neck 85″ and as a consequence, the horn 28″ and the horn retainers 78a″, 78b″ are integrally provided.

The operation of the horn retainers 78a″, 78b″ and other components are illustrated in FIGS. 15, 16 and 17. As shown from below in FIG. 15, again the window side frames 20″ include flanges or lips 34″ adjacent to the window sashes 14″, 16″ and extending along the length of the window side frame 20″ and which partially close off and define the window frame channel 24″, 26″. The slot opening 25″ into the channels 24″, 26″ is defined between the distal edges of the flanges 34″. The flanges 34″ define and provide a facing side edge surface of the window side frames 20″. The horns 28″ again include engagement features which project from the rear of the horns 28″ and engage the window side frame 20″, and in particular extend into and engage the window frame channel 24″. The engagement features again engage the flanges 34″ to thereby retain and locate the horn 28″ on the window side frame 20″ with the rear of the horn 28″ abutting against the facing surface of the flanges 34″. In this case, the engagement features are provided by the horn retainers 78a″, 78b″.

The engagement features are provided by the horn retainers 78a″, 78b″ because the width 82″ of the rearmost extension of the shell 30″ exceeds the width of the slot opening 25″. Hence the ends parts of the T shaped rearmost extension of the shell 30″ abut the rear face of the flanges 34″.

In this way, once again, the horn 28″ engages and is slideably mounted and located to the window side frame 20″ such that when installed it is slideable fixed and attached to the window side frame 20″ but can slide vertically along the length of the window side frame 20″ as shown in FIG. 2 for the previous embodiment.

The magnet 46″ acts in the same manner as described in the first embodiment to hold the horn 28″ in position relative to the bottom of sash frame 22″ of the window sash 16″.

With the long axis of the horn 28″ aligned with the axis of the channels 24″, 26″ in the window side frames 20″, as shown in FIGS. 15 and 16, the horn retainers 78a″, 78b″ hold the horn 28″ in position on the window side frames 20″. This orientation is also shown in the engaged position E in FIG. 17.

To attach a horn 28″ to the window side frame 20″, use is made of a location in the window side frames 20″ where a notch is cut out of the flanges 34″ on both sides of the channel 24″. The notches are of sufficient width to allow the insertion of the horn retainers 78a″ and 78b″ into the channel 24″. This attachment approach is shown in more detail in FIG. 18 in relation to a further embodiment of the horn 28″.

In FIGS. 18a and 18b, the horn 28′″ is provided with just a single horn retainer 78a∝″ on one side of the wider rearmost part of the extension of the shell 30′″ for both the top and bottom extension. As a consequence, a top notch 200 and a bottom notch 202 are provided cut out of the flange 34∝″ on one side of the channel 24′″. As shown in FIG. 18a, the horn 28′″ can be manoeuvred close to the window side frame 20′″, the top extension 204 can be aligned with the top notch 200 and the bottom extension 206 can be aligned with the bottom notch 202. The horn 28′″ is then positioned with the rear of the horn 28″ abutting against the facing surface of the flanges 34″ (as shown in FIG. 18b).

Movement of the horn 28′″ upward in the channel 24′″ moves the extensions 204, 206 out of alignment with the notches 200, 202 and so the horn 28′″ cannot be removed from the window side frame 20′″.

Once the horn 28′″ is engaged with the window side frame 20′″ the notches can be covered, for cosmetic reasons and/or to prevent accidental disengagement of the horn 28′″ by a cover plate (not shown). The cover plate may be a sash stop plate or other such device.

In the case of the horn 28′″ shown in FIGS. 15 to 17, an upper pair of notches and a lower pair of notches would be provided to allow the introduction of the horn retainers on both sides of the top and bottom extensions. Alternatively, the horn retainers on one side could be inserted into the channel at an angle and without the presence of notches, before pivoting the horn such that the other side approached the window side frame and the horn retainers on that side pass through the notches on that side and into the channel.

If it is desired to remove the horn 28′″ shown in FIG. 18b from the window side frame 20′″, then any cover, such as a cover plate, is removed. The horn 28′″ can then be moved down the channel 24′″ such that the top extension 204 is aligned with the top notch 200 and the bottom extension 206 is aligned with the bottom notch 202. The horn 28′″ can then be disengaged from the window side frame 20′″.

As a consequence of this design, the horn 28′″ can be quickly and easily introduced and removed from the window side frame 20″. Furthermore, the design can be retrofitted to existing sash window systems by forming the necessary notches in the necessary positions in the flange(s) 34′″ to one or both sides of the channel(s) 24′″. The horns 28′″ can be easily and quickly added, by snapping into position, to a completed window on the left and right sides and then easily and quickly positioned correctly against the sash 16′″. The top sash 16′″ can be readily tilted to open it, with the horn 28′″ becoming detached without any extra effort or manoeuvring. At the same time, the horn 28′″ remains connected to the window side frame 20′″, ready for when the window is closed again. If the user needs to bring the horn 28′″ up to the sash 16′″ again, this is easily achieved by the sliding mounting provided and the magnetic engagement then retain the horns 28′″ in the correct position on the sash 16′″ automatically. The attachment and detachment of the horn 28′″ is provided without any extra visible components and without any detrimental effect of the appearance of the window. The horn 28′″ can be provided in a style consistent with the original Georgian look. The single piece construction of the horn 28′″ and the means by which it engages the window side frame 20 make it cheaper to make and less liable to parts going missing (during installation and during subsequent use) than other designs. The installation is simple and reliable to achieve and does not impose any extra assembly costs or difficulties. The approach is widely applicable to retrofitting on existing window systems due to the steel bar used to provide the pivot. These benefits apply to the various embodiments described above.

As can be seen in FIG. 2, the sash 16 includes a thermal break material 45 which is used to insulate the inner part of the sash frame 22 from the outer part of the sash frame 22. When the horn 28 is in position, FIG. 1, it has the benefit of covering the thermal break material 45 and so providing extra thermal protection. This is particularly the case where aluminium extrusions are used.

The principle and mode of operation of this invention have been explained and illustrated in its preferred embodiment. However, it must be understood that this invention may be practiced otherwise than as specifically explained and illustrated without departing from its spirit or scope.

1. A sash window system comprising a window frame including a side frame member, a window sash slidably mounted within the window frame, and a horn detachably connected to the sash; wherein the horn further comprises at least one engagement feature which slidably engages the side frame member and slidably attaches the horn to the window frame to retain horn to frame while allowing the horn to slide along the side frame member.

2. A sash window system as claimed in claim 1 wherein the window side frame member comprises channel and the engagement features engage the channel.

3. A sash window system as claimed in claim 1 wherein the window side frame member comprises at least one flange and the engagement feature engages the flange.

4. A sash window system as claimed in claim 1 wherein the engagement feature comprises a projection from the horn which is engaged within the window side frame member.

5. A sash window system as claimed in claim 1 wherein the engagement feature is an integral part of the horn, for instance part of the same moulding.

6. A sash window system as claimed in claim 1 wherein the engagement feature comprises one or more elements extending from the horn, the one or more elements being connected to the horn by an arm of reduced width compared with the width of the one or more elements.

7. A sash window system as claimed in claim 1 wherein a first engagement feature is provided towards the end of the horn which is proximal the window sash in use and/or a second engagement feature is provided towards the end of the horn which is distal the window sash in use.

8. A sash window system as claimed in claim 1 wherein the engagement feature comprises a pair of arms extending from the horn and which is engaged within the window side frame member.

9. A sash window system as claimed in claim 1 wherein the engagement feature comprises a pair of engagement features.

10. A sash window system as claimed in claim 1 wherein the horn has an engaged position and wherein the horn has a released position, the horn being moved from the released position to the engaged position by passing at least a part of an engagement feature, such as an extension, through a part of the channel provided with an increased width and/or by passing at least a part of the engagement feature, such as an extension, through a gap in a part of the window side frame.

11. A sash window system according to claim 10 wherein the gap is notch in the window side frame.

12. A sash window system according to claim 10 wherein two or more gaps are provided, at least one side of the window side frame being provided with a gap for each engagement feature on the corresponding side of the horn.

13. A sash window system as claimed in claim 10 further comprising a detachable connection arrangement detachably connecting the horn to the sash.

14. A sash window system as claimed in claim 11 wherein the detachable connection arrangement comprises a magnetic connection.

15. A sash window system as claimed in claim 12 comprising a magnet mounted in and/or on the horn.

16. A sash window system as claimed in claim 1 wherein the sash is pivotally mounted to the window frame such that the sash can be pivoted out of the plane of the window frame.

17. A horn for use in system of claim 1 comprising at least one engagement feature for slidable engagement with the side frame member and slidably attaching the horn to the window side frame member to retain horn to frame while allowing the horn to slide along the side frame member.
